(19) United States
(12) Patent Application Publication
(10) Pub. No.: US 2018/0339244 A1
(43) Pub. Date: Nov. 29, 2018

(54) METHOD FOR CONTROLLING CONTINUOUS CHROMATOGRAPHY AND MULTI-COLUMN CHROMATOGRAPHY ARRANGEMENT

(71) Applicant: Karlsruher Institut für Technologie, Karlsruhe (DE)

(72) Inventors: Jürgen Hubbuch, Karlsruhe (DE); Nina Brestrich, Karlsruhe (DE); Matthias Rüdt, Karlsruhe (DE); Laura Rolinger, Karlsruhe (DE)

(73) Assignee: Karlsruher Institut für Technologie, Karlsruhe (DE)

(21) Appl. No.: 15/777,898

(22) PCT Filed: Nov. 25, 2016
(86) PCT No.: PCT/EP2016/001995

§ 371 Date: May 21, 2018

(30) Foreign Application Priority Data
Nov. 26, 2015 (EP) 15 196 599.3

(51) Int. Cl. B01D 15/18; G01N 30/86; G01N 30/46; G01N 30/78; G01N 30/74

(52) U.S. Cl. CPC B01D 15/1871; G01N 30/8675; G01N 30/8658; B01D 15/1814; G01N 30/78; G01N 30/74; G01N 30/46

(57) ABSTRACT

Methods of controlling at least one multi-column chromatography arrangement for the continuous process of purifying biopharmaceuticals are provided. The methods include introducing a first multi-component mixture into a column of the multi-column chromatography arrangement; detecting at least one multivariate signal by at least one detector; calculating at least one process parameter on the basis of the multivariate signal by at least one data-processing program of a computing unit via application of a chemometric method; and controlling the purification process via control of at least one controllable control element on the basis of the at least one process parameter.

The subject matter of the present invention refers to a method for controlling continuous chromatography by means of evaluating multivariate signals with mathematical methods. The method is particularly applicable in the area of purification of biopharmaceuticals. The purification of biopharmaceuticals is carried out for the most part by means of chromatographic separation procedures since these allow for high product purity while at the same time obtaining high yields. At present, in the biopharmaceutical industry a change is taking place from batch-based to continuous processes.

In this, one challenge is that biopharmaceutical processes are subject to a high variability compared to chemical processes. In order to maintain the stationary state in case of a continuous biopharmaceutical process thus an efficient process control is essential.

At present, the online process monitoring in chromatographic methods is limited to univariate process parameters, such as pH values, conductivity or absorption of the effluent. Only in offline analyses central process parameters are determined, for instance target protein content, concentration of coeluting contaminants, etc. However, these process parameters are required in real time in order to control a continuous chromatographic process.

WO 2014/154331 A1 discloses a method for infrared spectrophotometric quantitation of protein aggregates in samples containing biomolecules. The quantitation takes less time, no additional buffers or eluents and also less sample volume than conventionally known methods.

However, it is not possible with this method to directly or online, respectively, carry out spectroscopic measurements during the chromatographic process, and moreover the method is only directed towards the quantitation of protein aggregates on an additional substrate by means of Fourier-transform infrared spectroscopy.

WO 2010151214 A1 discloses a method for measuring the loading as well as the process control of the loading phases in a one- more multiple-column chromatography arrangement. To do so, a signal is recorded before and after the column and from the difference the loaded mass of binding species is concluded.

This method, however, necessarily requires two detectors, one being located before and one after the column. Moreover, the detection is limited to difference signals and process parameters calculated from them, such as saturation of the column, percentage breakthrough of the product.

For this reason it is the task of the present invention to provide a method which facilitates a continuous purification of biopharmaceuticals and is fast, robust, productive and cost-effective at the same time.

This task is solved by the subject matters of the independent claims, preferred embodiments are obvious from the dependent claims.

One aspect of the invention refers to a method for controlling at least one multi-column chromatography arrangement for a continuous process of purification of in particular biopharmaceuticals, as the case may be comprising virus fragments and/or viruses and/or proteins or protein mixtures, respectively, and/or mixtures containing viruses, preferably in solution, as the case may be in solution with other components, comprising:
introducing a multi-component mixture into a column of the multi-column chromatography arrangement,
detecting at least one multivariate signal by means of at least one detector,
calculating at least one process parameter based on the multivariate signal by means of a data processing program of a computing unit by applying a chemometric method and
controlling at least one controllable control element based on the at least one process parameter for controlling the purification process.

Advantageously it was discovered according to the present invention that chemometric processes or methods, respectively, can also be used for biopharmaceuticals, in particular protein mixtures, in order to be able to carry out a data evaluation on the basis of the multivariate signals, i.e. in particular one or more spectra, despite the multivariate signals being very similar or almost identical, respectively. In particular it was found that the chemometric processes can be used in a continuous process, even if mixtures are being purified whose single components have similar or almost identical multivariate signals.

In this, the focus of the present invention is that it refers in particular to an actual continuous process, which is also particularly advantageous for the biopharmaceutical industry in contrast to batch operation of also a high number of individual samples. According to the present invention, the term “continuous” in particular includes that both feed and discharge of the multi-component mixture or the product, respectively, is continuous. In this, the present invention refers preferably to the preparative chromatography, i.e. the purification of product mixtures at production-related scales—in contrast to a merely analytical chromatography.

Preferably, the method can comprise the further steps of:
comparing the at least one process parameter with at least one reference parameter and
determining at least one control signal on the basis of the process parameter.

The method of the present invention receives via at least one detector one or more multivariate signals from the multi-column chromatography arrangement and uses mathematical methods, such as partial least squares regression, artificial neural networks, Support Vector Regression, etc. in order to extract information regarding the at least one process parameter from calculations with the multivariate signal or signals. This information is then used for controlling the process of multi-column chromatography arrangement by means of at least one controllable control element, so that the best possible result is achieved, in particular a pure product or pure components.

According to a further embodiment, the method according to the invention uses at least two detectors. Depending on the objective, the at least two detectors can be of the same type or different from each other and provide independent multivariate signals.

Another aspect of the invention refers to a multi-column chromatography arrangement usable for a continuous process of the purification of biopharmaceuticals, comprising:

a) at least one first separation column and one second separation column each with at least one input and each with at least one output,

b) at least one first feed device suitable for transporting at least one first multi-component mixture, wherein the at least one first feed device is connected to the at least one input of the first separation column,

c) at least one first discharge device suitable for discharging a second multi-component mixture, wherein the at least first discharge device is connected to the at least one output of the first separation column,

d) at least one second feed device suitable for transporting a second multi-component mixture, wherein the at least second feed device is connected to at least one input of a second separation column,

e) at least one second discharge device suitable for discharging a third multi-component mixture, wherein the at least second discharge device is connected to the at least one output of the second separation column,

f) at least one detector for detecting a multivariate signal and

g) at least one computing unit with at least one data processing program with at least one chemometric calculation method,

wherein the at least one first discharge device is connected to the at least one second feed device;

wherein at least one of the first and second feed devices and/or at least one of the first and second discharge devices have at least one controllable control element;

wherein the at least one detector is arranged in front of at least one input and/or after at least one output; and

wherein the at least one detector is coupled to the at least one computing unit;

wherein the at least one computing unit is coupled to the at least one controllable control element and wherein the at least one computing unit is designed to
calculate the at least one process parameter based on the multivariate signal;
compare at least one process parameter with at least one reference parameter;
determine at least one control signal based on the process parameter; and
control at least one controllable control element based on the process parameter for controlling the purification process.

Advantageously the process parameters required for a continuous chromatographic process can be determined or detected, respectively, and controlled in real-time with such a multi-column chromatography arrangement. Furthermore, this has the advantage that a purification of a multi-component mixture is made possible in a continuous process and a best possible result is achieved, in particular a pure product or pure components of a multi-component mixture.

As mentioned the present invention is based on an actually continuous process concerning in particular preparative chromatography, i.e. the purification of product mixtures at production-related scales. Thus the multi-column chromatography arrangement defined in this specification is designed to guarantee such a continuous and preferably preparative purification process.

According to the present invention the multi-component mixtures can be complex mixtures, in particular of cell culture supernatants and/or supernatants of fermentations.

With regard to this application biopharmaceuticals can be drugs produced by means of biotechnology and genetically manipulated organisms. Biopharmaceuticals can comprise or consist of, respectively, the above mentioned multi-component mixtures. Biopharmaceuticals can comprise viruses and/or virus fragments as single component or one component of various components. Alternatively or additionally, biopharmaceuticals can comprise proteins and/or polypeptides as single component or one component of various components.

Likewise, a protein mixture which is being purified can comprise or consist of, respectively, the above mentioned multi-component mixtures.

Recording one or more signals in the multi-column chromatography arrangement takes place by the at least one detector, which can be arranged in an area of the feed and/or discharge of a separation column. The at least one detector is connected for signaling to at least one computing unit. The signals detected or recorded, respectively, by the detector can be processed by means of a preferably chemometric model or chemometric method by at least one data processing program of the computing unit.

According to another embodiment the multi-column chromatography arrangement according to the invention comprises at least two detectors. The at least two detectors can be of similar type or different depending on the objective and can provide independent multivariate signals.

Chemometrics comprises mathematical and statistical methods for planning and selecting optimum measurement methods and experiments and is also used for acquiring maximum chemical information when analyzing chemical data. Apart from the statistical-mathematical methods also problems of a computer-based connected laboratory, methods for managing chemical and spectroscopic databases as well as methods of artificial intelligence are part of chemometrics (CA, Römp-Online; http://d-nb.info/gnd/4299578-4).

The corresponding evaluation can for instance include the calculation of individual concentrations and/or classification into correct or incorrect. The process decision or process control, respectively, then takes place based on the result of the evaluation of the for instance chemometric method. In this way, for instance the interconnection of the columns with each other can be changed, quantitative signals be tapped, the duration of specific phases of a process determined and/or robustness controls be carried out.

Such a process control can be advantageous in particular in continuous chromatography processes since it is fast and robust. Further advantages are on the one hand that the process can be carried out in real-time, on the other the possibility of quantitative evaluation and robustness analysis. The term real-time characterizes the operation of information technology systems, which are able to deliver specific results reliably within a predetermined period of time, for instance in a fixed time frame.

The period of time can preferably be under 1 minute, more preferably less than 30 seconds, also preferred less than 10 seconds, even more preferred less than 5 seconds and most preferred less than one second.

In continuous chromatography several separation columns are connected to each other in an arrangement in such a way that, depending on the requirements, the columns can be connected in parallel and/or in series and/or every column can be connected to every other column of the multi-column chromatography arrangement. By doing so, a chromatographic run can be carried out for instance with one column, with several or with all columns at the same time.

In traditional chromatographic methods a chromatographic cycle consists of several consecutive steps, such as loading, washing, eluting and regenerating the column. In continuous chromatography usually several identical columns are used. The above mentioned steps can thus for instance take place at the same time, wherein at the same time in general a different step takes place in every individual column.

By doing so, by means of continuous chromatography the processing time can be shortened. Thus the method is significantly more economic and efficient compared to traditional batch methods.

The multi-column chromatography arrangement of the present invention can be a standard multi-column chromatography arrangement and/or an arrangement of individual single column chromatography arrangements. For the sake of convenience, in this application the chromatography columns or separation columns, respectively, are called columns. Moreover, a column can also be a membrane arrangement or a monolith. Monoliths are separating media in a form that can be compared to a single large particle and which does not contain interparticular voids. Column may also refer to a packed fiber bed, wherein the fibers conventionally are functionalized. A bed packed with adsorber particles can also be meant by column.

The respective columns preferably have one input and preferably one output. However, it can also be provided that one or more columns also have a plurality of inputs and/or outputs.

Introducing a multi-component mixture into a column of the multi-column chromatography arrangement takes place by means of a feed device. At least one feed device is arranged on every column. However, it can also be provided that solvents and/or cleaning solutions can be introduced.

The at least one feed device can be designed in such a way that in particular biopharmaceuticals, for instance multi-component mixtures of proteins, can be introduced into the column.

The feed device can be connected to a production chain for biopharmaceuticals, for instance a bioreactor. Further, the feed device can also comprise at least one pump, which introduces or guides, respectively, a multi-component mixture via the feed device into the column. A multi-component mixture can be mixed or diluted, respectively, with a mobile phase. The dilution of the multi-component mixture can for instance take place before the feed device. However, it can also be provided that mixing the multi-component mixture with the mobile phase takes place in the feed device.

However, the multi-component mixture can also be concentrated before the chromatography so that a possible shift of an absorption weight can be avoided.

Due to the different interaction of the individual components of a multi-component mixture with the stationary and the mobile phase of the column, the individual components are spatially separated during the chromatographic run.

A detector is arranged after or behind, respectively, at least one column of the multi-column chromatography arrangement. However, this can also mean that the detector is arranged before a next column or between two columns, respectively. The detector can also be arranged before a column and another detector after the column. Also several detectors can be arranged before and after each column. The at least one detector is designed to detect multivariate signals. The detector detects a multivariate signal as soon as a component or a component mixture of the original multi-component mixture passes the detector.

Preferably, a detector is arranged after a first column of the multi-column chromatography arrangement. More preferably, after several or after every column a detector is arranged. When using at least two detectors these can be arranged at different positions of the multi-column chromatography arrangement, according to the requirements and process control.

Preferably, the at least one detector is a detector which is able to detect at least one multivariate UV, vis, fluorescence, scattered light, infrared and/or Raman signal. The at least one detector is coupled or connected for signaling or connected for data transfer, respectively, with at least one computing unit. A multivariate signal thus can for instance be a spectrum, such as an absorption spectrum, an infrared spectrum and/or a fluorescence spectrum. In other words, a multivariate signal can contain radiation intensities as function of the wavelength of the radiation, whereas a univariate signal merely contains exactly one radiation intensity at exactly one wavelength. When using at least two detectors these can provide signals of the same kind (for instance UV signals in each case) or signals of different kind (for instance UV signals and IR signals).

In this case a multivariate signal is a signal which in contrast to the univariate signal does not consist only of one value but of many independent signals, e.g. time-resolved spectral data. So these signals can correlate (strongly). Other possible multivariate signals can be signals which can be obtained by means of UV, vis, fluorescence, infrared, Raman spectroscopy and/or scattered light.

The at least one multivariate signal is then used for calculating at least one process parameter. The multivariate signal detected by the detector can be received by the at least one computing unit. The at least one computing unit comprises at least one data processing program with a chemometric procedure/method and/or carries out a data processing program with a chemometric procedure/method. Calculating the at least one process parameter takes place by means of the at least one data processing program.

A process parameter can be or comprise one or more of the following parameters:
pH value,
conductivity,
absorption of the effluent,
target protein content,
concentration of coeluting contaminants,
product concentration,
purity,
yield,
production rate and
In and out of specification.

In other words, process parameters can be all parameters which can be monitored, controlled and/or regulated in the process, in particular concentrations, purities and/or whether the process takes place within the specifications.

Preferably, the at least one data processing program can calculate process parameters such as the concentration of at least one or various or all components of a multi-component mixture. More preferably, the at least one data processing program can for instance also be the product purity, yield, production rate, profitability of the installation and/or In and out of specification (compliance with quality policies).

The process parameter/s are then compared with at least one reference parameter. In other words, the determined process parameters (for instance associated with fractions) can be examined with regard to the concentration of relevant species. For instance, absorption spectra can be averaged corresponding to the time duration of a fraction.

A signal deconvoluted in this way can be used to control the chromatographic purification. In this, depending on the application, the deconvoluted signal is used to control valves and/or pumps or other controllable elements of the multi-column chromatography arrangement.

In other words, the method of the present invention can also comprise the steps of:
determining the product concentration in the multi-component mixture at the feed device by means of the signal of the detector, which is preferably arranged at an output of a column,
calculating the current product mass by means of the determined product concentration and a current flow rate,
comparing the currently loaded product mass with a control value, and
controlling the at least one control element in order to in particular set the interconnection of the columns based on the comparison of the currently loaded mass and the control value.

This is particularly advantageous since thus a purification process can be optimized and the yield be increased.

A training and validation of the mathematical model can take place by means of a statistical method. In this, for instance the flow from the multi-component mixture in a mobile phase, which in this application is designated as feed, can be mixed with variable shares of product and contaminants in order to replicate process variation during a continuous process. Additionally, a retention time of the product in the column during the loading phase can be varied.

Preferably, the calculation of the at least one process parameter can be carried out by means of the at least one data processing program, wherein the data processing program can comprise or execute a chemometric method. The chemometric method can be or comprise inter alia for instance Multiple Linear Regression, Principle Component Regression, Partial Least Squares (PLS) Regression, Principal Component Analysis, calculations by means of Neural Networks (NN), Support Vector Machines and/or Multivariate Curve Resolution. A combination of these methods is also possible.

A training and validation of the mathematical model can take place by means of several chromatography runs with for instance variable length of salinity gradients in a cation exchange step. For training, component concentrations can exactly be determined by means of analytical methods.

The term cation exchange step is a purification step based on cation exchange chromatography.

In this, the variations of the gradient length can lead to different concentration ratios of the species in the effluent, which span the calibration space. Additionally, within this space a validation step can be carried out. For instance, both a Partial Least Squares Regression model and for instance an Artificial Neural Network can be calibrated from the data.

For instance, a calibrated PLS model can be used for controlling the fractioning of a target protein in real-time in a polishing step. Since in traditional methods the separation of product and contaminants differs from batch to batch due to process variations in the production of the multi-component mixture and product and contaminants cannot be selectively detected this leads to variable product qualities. According to the present invention, advantageously also in case of process variations in the production of the multi-component mixture it is possible to also selectively detect by means of the deconvoluted multivariate signal at which point of time the desired product quality is reached, and by means of this information an controllable control element, for instance a valve of the multi-column chromatography arrangement can be controlled for optimized fractioning of the product.

All in all, the method of the present invention for process monitoring and control can be used for controlling a chromatographic separation of multi-component mixtures. This is essentially central for continuous processes since in this case the process cannot be stopped for Offline Analytics and errors may accumulate from cycle to cycle. By means of the method of the present invention, however, the stationary state can be controlled easily and without interruption for Offline Analytics.

The method of the present invention is particularly suited for a continuous process of purification of in particular biopharmaceuticals. The detected signals and the evaluation by means of mathematical methods in this case is of particular advantage since the process parameters calculated from it are obtained in real-time and thus a continuous chromatographic method according to the invention is fast, robust, and efficient. Another advantage is that during the purification of a multi-component mixture an optimum result is achieved, in particular an essentially pure product or essentially pure components of a multi-component mixture.

The use of the term “pure product” or the term “pure”, respectively, in principle depends on the protein and process processed for instance. The meaning of “pure” among experts has also changed in the past years. Also, differences are made between different contaminants. In particular viruses and Host Cell Proteins must be cleaned very strongly.

Depending on the application, detectors can be arranged and controlled at different locations in the multi-column chromatography arrangement.

Preferably, the method of the present invention may comprise the further steps of:
evaluating a multivariate signal of the at least one detector by means of the at least one computing unit, wherein the detector is preferably arranged at an output of a column so that the component concentration in the multi-component mixture is detected at the discharge device,
determining the saturation and/or breakthrough point of the at least one column by means of the detected component concentration and
controlling the at least one control element in order to set the interconnection of the columns based on the detected saturation and/or the breakthrough point.

For instance, the method can be used for controlling the load duration in the continuous process. In the continuous production of biopharmaceuticals the product concentration may vary due to variability in the upstream. However, the feed concentration cannot be detected in the feed line with traditional, univariate detectors. Since, however, usually the columns have a limited capacity, which moreover can change by ageing of the columns, a detection of the loaded product mass is critical. This can be achieved in real time by means of the deconvoluted, multivariate signals of for instance two detectors, each of which can be connected before and after at least one column.

For instance, if the feed or stream, respectively, of the multi-component mixture is guided in a mobile phase via or past, respectively, a first detector, which is arranged before a first column, onto the first column. Subsequently, the feed is guided via or past a second detector, respectively, onto a second column, the detector being arranged after the first column. By means of the integration of the deconvoluted multivariate signal of the first detector the loaded product mass can be calculated continuously or online, respectively. Since the capacity of the columns can be changed by ageing the controlling of the interconnection of columns takes place by means of the deconvoluted multivariate signal from the second detector. In this example, the latter is always located on the downstream side of the column. If a specific threshold value of the product concentration is reached at the output of the first column, the position of a control element, for instance of a valve or pump, respectively, can be changed in such a way that the feed is pumped or guided, respectively, onto the second column and guided onto a third column via the second detector. The above described process can be cyclically repeated continuously for all columns.

Preferably, the method of the present invention can comprise the further steps of:
detecting the concentration of the single components, namely for instance of one, several, preferably all single components, by evaluating the at least one multivariate signal of at least one detector by means of the at least one computing unit, wherein the at least one detector is arranged between two columns,
calculating a mass percent of at least one component,
comparing the determined mass percent with a control value by means of the computing unit and
controlling the at least one control element in order to set the interconnection of the columns and/or fractioning of a product and/or rejecting of fractions based on the control value.

For instance, the method can be used to perform the fractioning of a multi-component mixture in the continuous process. In the product eluation of the column in the continuous method the decision must be taken, via a valve which preferably is arranged after the columns of a multi-column chromatography arrangement, whether the effluent is fractioned, recycled or rejected.

In other words, the method of the present invention can further comprise a controlling of a recycling of incompletely separated areas.

By means of process variations the separation of product and contaminants can change in the continuous process.

Since product and contaminants cannot be selectively detected by means of traditional methods, a process-oriented control of the above described valve as control element via univariate measurement methods can be complex. In this, in the worst case errors may accumulate and the process can become instable. This may negatively affect the product quality and yield.

By means of the deconvoluted multivariate signal from a detector, which preferably is arranged after the columns of the multi-column chromatography arrangement and before the valve as control element, in contrast it is possible to selectively detect at which point of time the desired product quality or yield is given. The valve can be controlled by means of this information.

In other words, the method of the present invention can preferably further comprise the steps of:
calculating new optimized process parameters by means of a mathematical model of the computing unit on the basis of the at least one calculated process parameter and
setting the control element on the basis of the calculated process parameters in order to obtain new optimized process parameters.

In the following, the subject matter of the invention is described by means of embodiments.

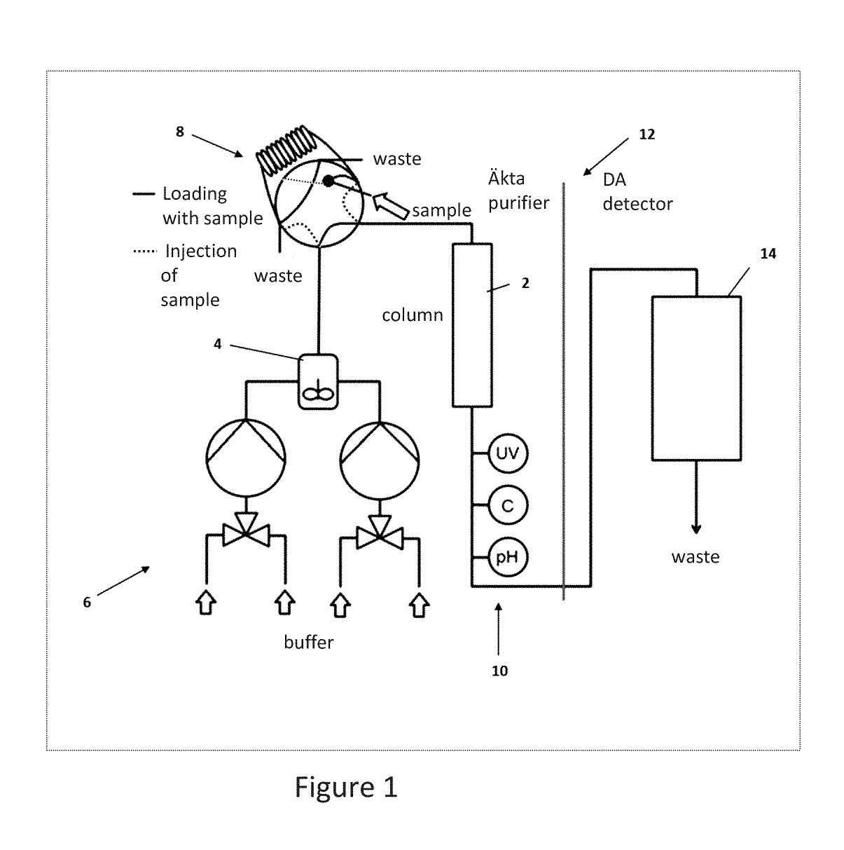

FIG. 1 shows an experimental set-up in batch mode of a chromatography arrangement (schematic representation of Akta pure of the company GE Healthcare, Chalfont St. Giles, UK) with a diode array detector (DAD).

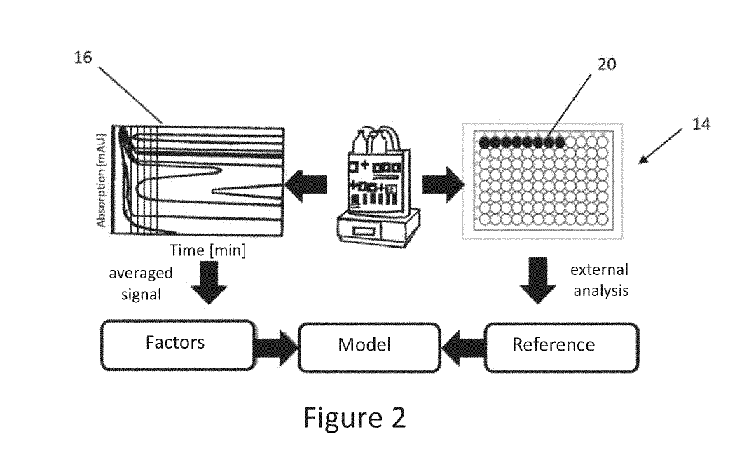

FIG. 2 shows an exemplary flow of information for the calibration of a mathematical model.

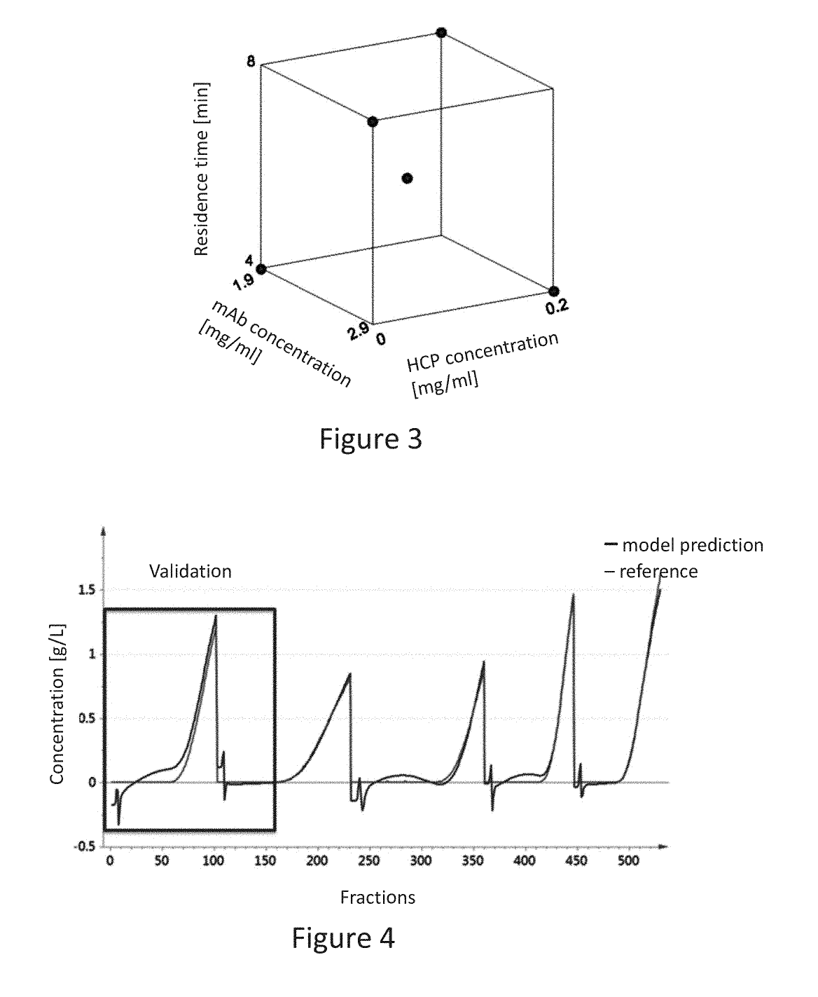

FIG. 3 shows an exemplary statistical experimental plan for model calibration and validation for the control of the load duration.

FIG. 4 shows an exemplary comparison of a PLS model prediction with a reference analysis.

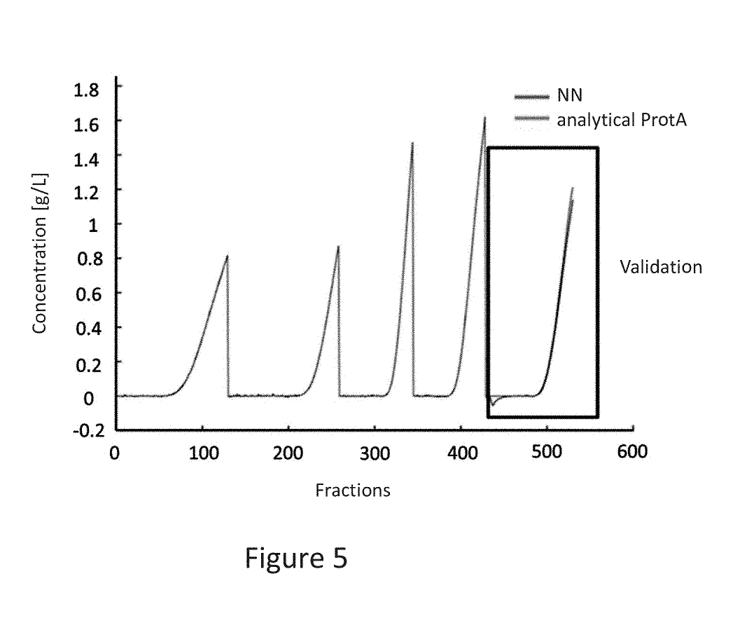

FIG. 5 shows an exemplary comparison of an NN model prediction with the reference analysis.

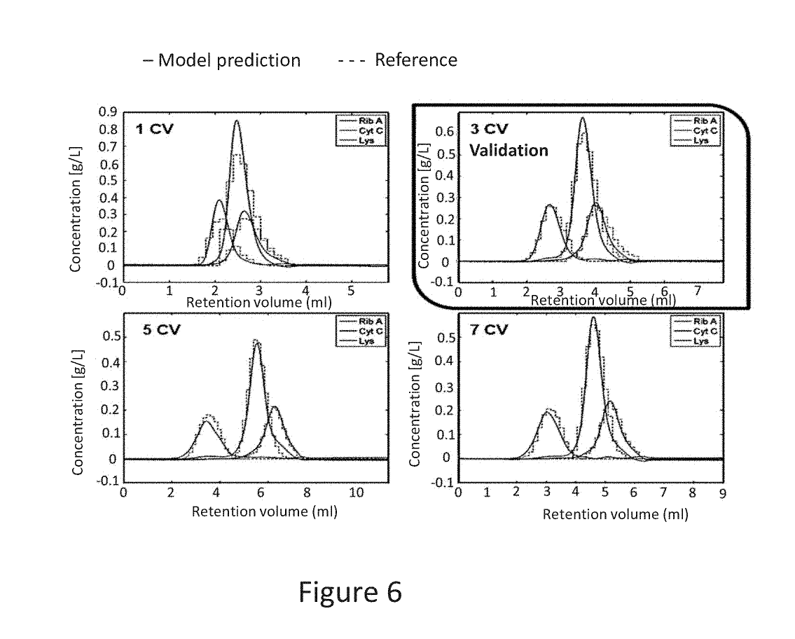

FIG. 6 shows an exemplary comparison of a PLS model prediction with the reference analysis.

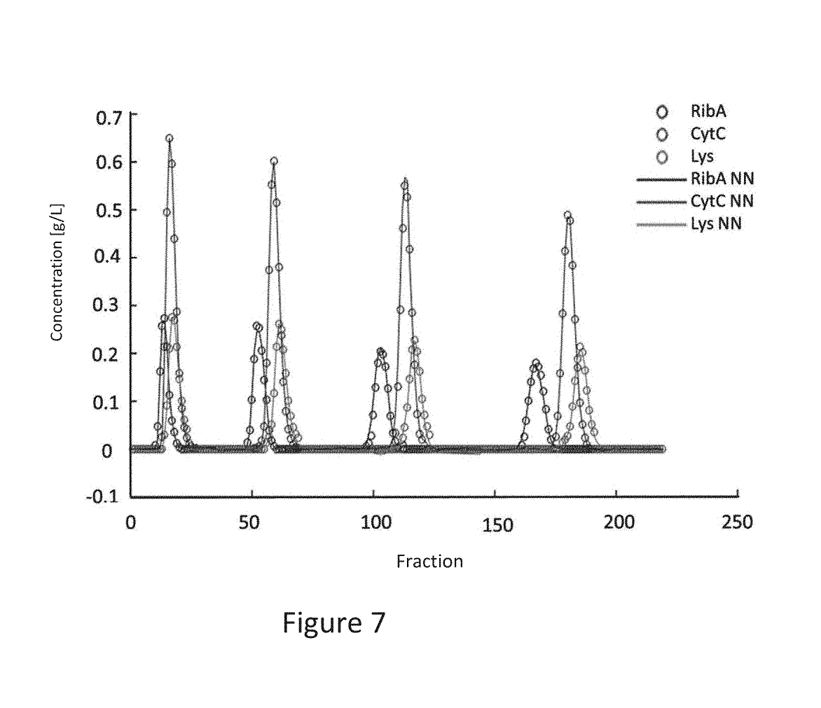

FIG. 7 shows an exemplary comparison of the NN model prediction with the reference analysis.

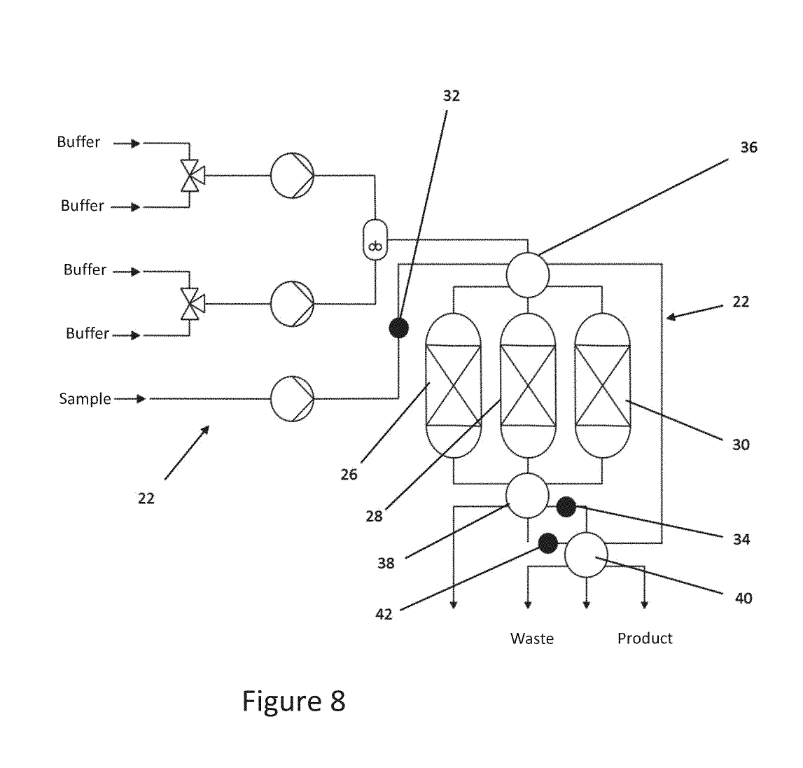

FIG. 8 shows a pipeline and instrument flow chart for controlling continuous chromatography.

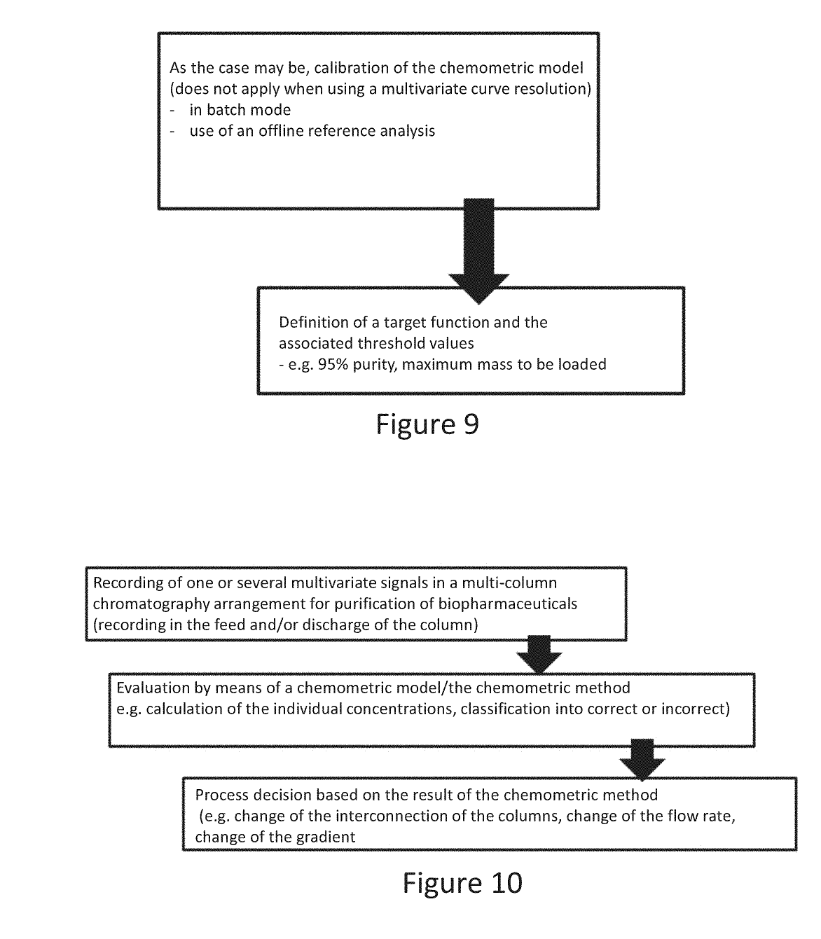

FIG. 9 shows a flow diagram for general preparatory works.

FIG. 10 shows a flow diagram for a general example for a process control.

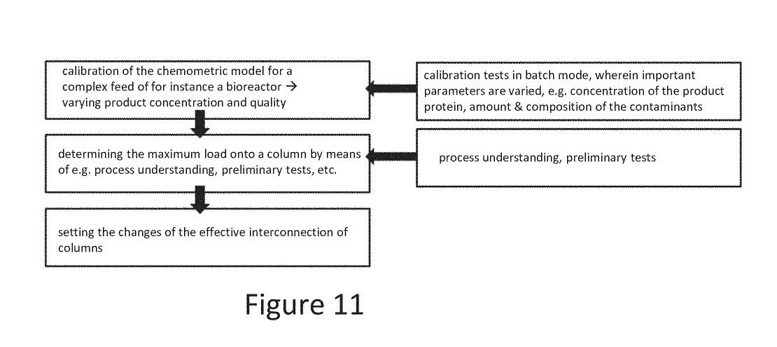

FIG. 11 shows a flow diagram of a specific example for a preparatory work.

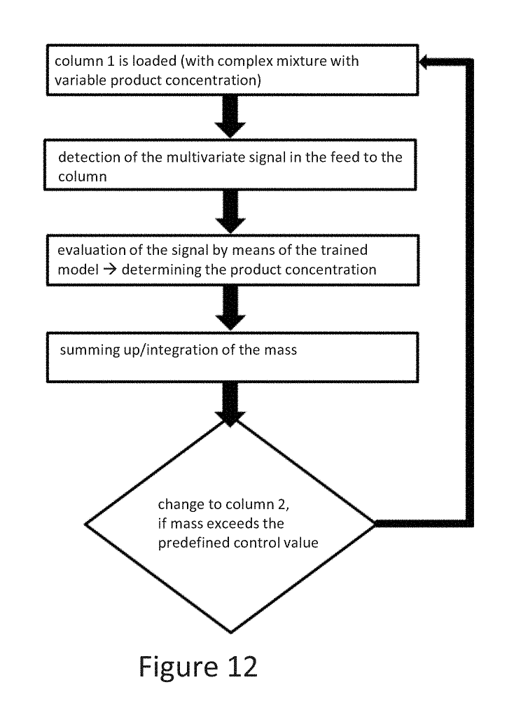

FIG. 12 shows a flow diagram for a specific example for a process control.

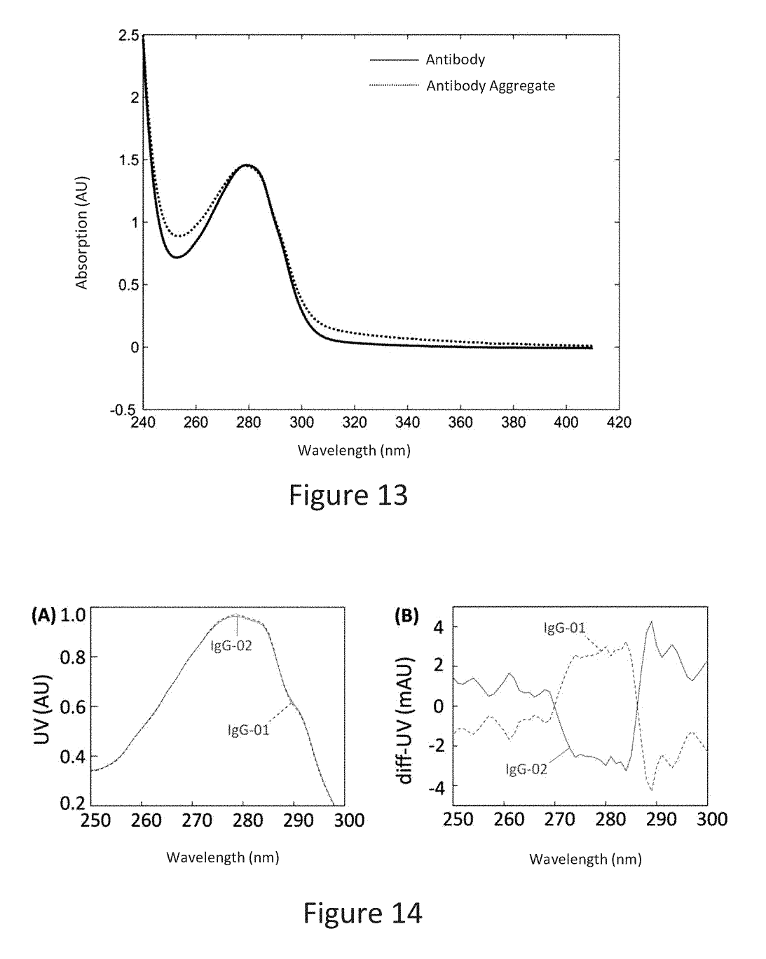

FIG. 13 shows two absorption spectra of antibody and antibody aggregates.

FIG. 14 shows the spectral difference in the UV area between antibody and antibody aggregates (A) and an associated difference spectrum (B).

FIG. 1 shows an experimental set-up for an experiment with a chromatography arrangement in batch mode. A stock of a mobile phase 6, a control element 4, a column 2, a feed device 8, internal detectors 10, a diode array detector (DAD) 12 and a fraction device 14 are shown. The chromatography arrangement exemplarily described here is the chromatography arrangement distributed under the name Akta pure by GE Healthcare, Chalfont St. Giles, UK. Additionally, a DAD 12 is arranged in the chromatography arrangement, which is distributed under the name Ultimate 3000 by Dionex, Fisher Scientific, USA. As described above, several chromatographic separations can be performed under different conditions for training and validation of the mathematical models used. In this, the effluent of column 2 is guided via the DAD 12 and subsequently fractioned in all experiments. In this, DAD 12 continuously taps absorption spectra.

As shown in FIG. 2, fractions 20 can then be examined with an external reference analysis 18 (analytical chromatography) with regard to the concentration of relevant species. Absorption spectra 16 have been averaged corresponding to the time duration of a fraction 20. Subsequently, the mathematical models are calibrated with the training data and verified on the basis of the validation data.

A first embodiment shows the control of the load duration. The training and validation of the mathematical model take place on the basis of a statistical experimental design, shown in FIG. 3. In this, the feed is added variable percentages of product and contaminants in order to replicate process variation during a continuous process. Additionally, the retention time of the product in column 2 during the load phase is varied. The center point of the statistical experimental plan represents the validation batch.

From the data both a Partial Least Squares (PLS) Regression model and an Artificial Neural Network (NN) are calibrated or trained, respectively. A comparison of the model prediction and the reference analysis for the training and validation data is shown in FIG. 4 for the PLS model and in FIG. 5 for the NN model.

The calibrated PLS model can subsequently be used for controlling the load phase during a protein chromatography. In this, it is advantageous that the calibrated PLS model can be used for the online process monitoring and thus allows for a continuous purification of multi-component mixtures without an offline analysis of the feed being required. Since the product concentration is variable at the same time and also the capacity of the column can change by ageing, in every new batch the titer must first be determined offline before the process can be continued.

Additionally, extensive studies must be carried out in order to examine the column ageing. In contrast, by means of the deconvoluted multivariate signal it is possible to determine at the output of the column if the product breaks through. By means of this information a corresponding valve can be connected as control element and the pump operation of the feed be terminated at a suitable point of time.

Another exemplary embodiment is the control of the fractioning of a target product.

The training and validation of the mathematical model take place by means of several chromatography runs with variable length of the salinity gradients (1, 3, 5, 7 column volume [CV]) in a cation exchange step. In this, the variation of the gradient length results in different concentration ratios of the species in the effluent which span the calibration space. Additionally, within this space a validation batch can be carried out.

From the data, both a Partial Least Squares Regression (PLS) model and an Artificial Neural Network (NN) are calibrated. A comparison of the model prediction and the reference analysis for the training and validation data is shown in FIG. 6 for the PLS model and in FIG. 7 for the NN.

The calibrated PLS model is subsequently used for controlling and thus optimizing the fractioning of a target protein in real-time in a polishing step. The problem solved this way is that the separation of product and contaminants may vary from batch to batch due to process variations. Since product and contaminants cannot be selectively detected this leads to variable product qualities. In contrast, by means of the deconvoluted multivariate signal it is possible to selectively detect at which point of time the desired product quality is reached, and by means of this information the valve for fractioning the product can be controlled.

In total, the method according to the invention for controlling and monitoring processes can be used to control chromatographic separations. This is in particular essential for continuous processes, since in them the process cannot be stopped for an offline analysis and errors may accumulate from cycle to cycle. However, by means of the method according to the invention the stationary state can easily be controlled.

In the following, the execution of the embodiments in continuous chromatography is exemplarily described.

The above described method for process control can be used in continuous chromatography. In this, the detected signals and evaluation by means of mathematical methods remains identical to the batch mode. However, what is different is how the deconvoluted signal is used for controlling the valves. Such a concept is shown in FIG. 8. Depending on the application, detectors are integrated in different places into the pipelines 22 of the multi-column chromatography arrangement.

Exemplarily, the method for controlling the load duration can be used in the continuous process. In the continuous production of biopharmaceuticals the product concentration can vary by variability in the upstream and cannot be detected in the feed line with traditional, univariate detectors. However, since columns 26, 28, 30 have a limited capacity, which moreover can change by ageing of the columns, a detection of the loaded product mass is critical. This can be achieved in real time by means of the deconvoluted, multivariate signals of detectors 32 and 34 in FIG. 8.

Assuming that the feed is pumped via detector 32 onto column 26 and subsequently guided via detector 34 onto column 28. By means of the integration of the deconvoluted multivariate signal of detector 32 the loaded product mass can be continuously calculated.

Since the capacity of the columns may change by ageing, the controlling of the interconnection of columns takes place by means of the deconvoluted multivariate signal of detector 34. The latter is always located between loaded and receiving column. If a specific threshold value of the product concentration is reached at the output of column 26, the position of valves 36 and 38 can be changed in such a way that the feed is guided onto column 28 and via or past, respectively, detector 34 onto column 30. The above described process is cyclically repeated continuously for all columns 26, 28, 30.

Another example for an application of the method of the present invention is the control of the fractioning in the continuous process.

In the product eluation of column 26, 28, 30 in the continuous method the decision must be taken via valve 40 whether the effluent is fractioned, recycled or rejected. By means of process variations the separation of product and contaminants can change in the continuous process.

Since product and contaminants cannot be selectively detected by means of traditional methods, a process-oriented control of valve 40 via univariate measurement methods can be complex. In this, in the worst case errors may accumulate and the process can become instable. This can negatively affect the product quality and yield. By means of the deconvoluted multivariate signal of detector 42, however, it is possible to selectively detect at which point of time the desired product quality or yield is given as preferred process parameter. Based on this information valve 40 can be controlled.

FIGS. 9 and 10 show exemplary flow diagrams for preparatory work and for the process control for an exemplary specific case. As the case may be, a calibration of a chemometric model is performed. This does not apply when using a multivariate curve resolution. The calibration first takes place in batch mode as well as using an offline reference analysis.

Thus it is possible by means of the calibration to define a target function and to determine the associated threshold values, such as a specific purity and/or the maximum mass to be loaded.

The data thus obtained are then used for the continuous multi-column chromatography for purifying biopharmaceuticals (FIG. 10). At least one multivariate signal in a multi-column chromatography arrangement is recorded. The recording takes place by means of detectors in the feed and/or discharge of the columns.

The at least one recorded multivariate signal is then evaluated by means of at least one chemometric model or a chemometric method, respectively, for instance in a calculation of the individual concentrations and/or classification into correct or incorrect.

Based on the results of the chemometric method the process decision is taken, for instance a change of the interconnection of the columns and/or the flow rate and/or the gradient.

FIG. 11 shows an exemplary flow diagram for the preparatory work for an exemplary general case.

The calibration of the chemometric model for a complex feed of for instance a bioreactor is first made possible by means of calibration tests in batch mode. A feed of for instance a bioreactor traditionally has a varied product concentration and quality. In the calibration tests in batch mode therefore important parameters are varied, for instance concentration of the product protein, amount and composition of the contaminants. Further, the maximum load mass on a column is set. These variations are set based on preliminary tests, process understanding, etc. Subsequently, the change of the effective interconnection of columns is set.

FIG. 12 shows an exemplary flow diagram for the process control for an exemplary general case.

The first column of a multi-column chromatography arrangement is loaded with a complex mixture with variable product concentrations. A multivariate signal is detected in the feed to the column. The signal is then evaluated by means of the trained model and thus for instance the product concentration is determined. As a further step then summing up or integration, respectively, of the masses of the individual components of the mixture takes place.

The term mass in this case refers to the currently loaded product mass on the first column. Moreover, in the concretely described example only product concentration and loaded product mass are determined.

The next step is the change to a second column of the multi-column chromatography arrangement if the mass exceeds the predefined control value. The process can then be repeated for the second column.

FIG. 13 shows two exemplary absorption spectra. One absorption spectrum refers to an antibody and is shown in FIG. 13 as solid line. The spectrum represented in FIG. 13 as dotted line refers to an antibody aggregate. It is clearly discernible how little the differences between the spectra are. In particular, it had been assumed before the invention that due to the slight differences between such spectra such spectra cannot be used for controlling a continuous multi-column chromatography. However, according to the present invention it was recognized that it is possible by means of chemometric methods, in particular PLS and/or neural networks, due to the low but existing spectral differences to control a multi-column chromatography in such a way, in particular to take process decisions, in order to control a purification process in such a way that a biopharmaceutical and/or protein and/or protein mixture and/or otherwise requested product to extract with sufficient purity. Thus for instance a requested antibody can be selectively quantified in or extracted from, respectively, multi-component mixtures, i.e. purified, despite the spectra only differing in the mAU area.

FIG. 14a shows the UV spectra of two components in a component mixture which are denominated IgG-01 and IgG-02. FIG. 14b shows a difference spectrum of both spectra of FIG. 14a. By means of the method according to the invention it is possible to selectively quantify both antibodies IgG-01 and IgG02 in a mixture and extract, i.e. purify in each case, both from the mixture, though, as discernible from FIG. 14b, the spectral differences are smaller by about three dimensions than the standardized spectrum intensities.

1. A method for controlling at least one multi-column chromatography arrangement for a continuous process of purification of biopharmaceuticals, comprising:
introducing a first multi-component mixture into a column of the multi-column chromatography arrangement,
detecting at least one multivariate signal by at least one detector,
calculating at least one process parameter based on the multivariate signal by at least one data processing program of a computing unit by applying a chemometric method and
controlling the purification process by controlling at least one controllable control element based on the at least one process parameter.

2. The method according to claim 1, wherein the method comprises the further steps of:
comparing the at least one process parameter with at least one reference parameter and
determining at least one control signal on the basis of the process parameter and wherein the purification process is controlled by controlling the control signal.

3. The method according to claim 1, wherein the at least one data processing program calculates the concentration of at least one component of the at least one multi-component mixture as process parameter.

4. The method according to claim 1, wherein the at least one data processing program calculates at least one of the following process parameters:
pH value,
conductivity,
absorption of the effluent,
target protein content,
concentration of coeluting contaminants,
product concentration,
purity,
yield,
production rate and
in and out of specification.

5. The method according to claim 1, wherein the at least one detector is configured to record at least one multivariate signal, wherein the multivariate signal comprises one or more of the following signals:
UV spectroscopy signal,
vis spectroscopy signal,
fluorescence spectroscopy signal,
scattered light signal,
infrared spectroscopy signal and
Raman spectroscopy signal.

6. The method according to claim 1, wherein the calculation of at least one process parameter by means of the one data processing program is carried out by means of at least one of the following chemometric methods: Partial Least Squares Regression and/or calculations by means of a neural network.

7. The method according to claim 1, wherein the method further comprises:
determining the product concentration in the multi-component mixture at the feed device by means of the detector, which is preferably arranged at an output of a column,
calculating the current product mass loaded onto a column by means of the determined product concentration and a current flow rate,
comparing the currently loaded product mass with a control value, and
controlling at least one controllable control element based on the currently loaded mass for controlling the purification process.

8. The method according to claim 1, wherein the method further comprises:
evaluating a multivariate signal of the at least one detector by means of the at least one computing unit, wherein the detector is preferably arranged at an output of a column so that the component concentration in the multi-component mixture is detected at the discharge device,
determining the saturation and/or breakthrough point of the at least one column by means of the detected component concentration and
controlling the at least one control element in order to set the interconnection of the columns based on the detected saturation and/or the breakthrough point.

9. The method according to claim 1, wherein the method further comprises:
detecting the concentration of one or several, in particular all single components by evaluating the at least one multivariate signal of at least one detector by means of the at least one computing unit, wherein the at least one detector is arranged between two columns,
calculating a mass percent of at least one component,
comparing the determined mass percent with a control value by means of the computing unit and
controlling the at least one control element in order to set the interconnection of the columns and/or fractioning of a product and/or rejecting of fractions based on the control value.

10. The method according to claim 1, wherein the method further comprises the controlling of a recycling of incompletely separated areas.

11. The method according to claim 1, wherein the method further comprises:
calculating new optimized process parameters by means of a mathematical model on the basis of the at least one calculated process parameter; and
setting the control element on the basis of the calculated process parameters in order to obtain new optimized process parameters.

12. A multi-column chromatography arrangement usable for a continuous process of purification of biopharmaceuticals, comprising:
at least one first separation column and one second separation column, each with at least one input and each with at least one output,
at least one first feed device suitable for transporting at least one first multi-component mixture, wherein the at least one first feed device is connected to the at least one input of the first separation column,
at least one first discharge device suitable for discharging a second multi-component mixture, wherein the at least first discharge device is connected to the at least one output of the first separation column,
at least one second feed device suitable for transporting a second multi-component mixture, wherein the at least second feed device is connected to at least one input of a second separation column,
at least one second discharge device suitable for discharging a third multi-component mixture, wherein the at least second discharge device is connected to the at least one output of the second separation column,
at least one detector for detecting a multivariate signal, and
at least one computing unit with at least one data processing program with at least one chemometric calculation method,
wherein the at least one first discharge device is connected to the at least one second feed device;
wherein at least one of the first and second feed devices and/or at least one of the first and second discharge devices have at least one controllable control element;
wherein the at least one detector is arranged before at least one input and/or after at least one output;
wherein the at least one detector is coupled to the at least one computing unit;
wherein the at least one computing unit is coupled to the at least one controllable control element and wherein the at least one computing unit is configured to:
calculate the at least one process parameter based on the multivariate signal, and
control at least one controllable control element based on the at least one process parameter.

13. The multi-column chromatography arrangement according to claim 12, wherein the computing unit is further configured to:
compare at least one process parameter with at least one reference parameter;
determine at least one control signal based on the process parameter and
control the purification process by means of controlling the control signal.

14. The multi-column chromatography arrangement according to claim 12, in a continuous process of purification of in particular biopharmaceuticals, wherein the multi-component mixtures are complex mixtures, in particular of cell culture supernatants and/or supernatants of fermentations.

15. The multi-column chromatography arrangement according to claim 13, in a continuous process of purification of in particular biopharmaceuticals, wherein the multi-component mixtures are complex mixtures, in particular of cell culture supernatants and/or supernatants of fermentations.
